(19) United States
(12) Patent Application Publication
(10) Pub. No.: US 2026/0198727 A1
(43) Pub. Date: Jul. 16, 2026

(54) SPECIFIC COOKING VESSEL FOR MICROWAVE OVEN

(71) Applicant: HUAMIN PENG, Foshan City (CN)

(72) Inventor: HUAMIN PENG, Foshan City (CN)

(21) Appl. No.: 19/564,102

(22) Filed: Mar. 11, 2026

Related U.S. Application Data
(63) Continuation of application No. PCT/CN2023/134635, filed on Nov. 28, 2023.

(30) Foreign Application Priority Data
Nov. 20, 2023 (CN) 202323139035.7

(51) Int. Cl. A47J 37/01; A47J 36/02; A47J 37/06

(52) U.S. Cl. CPC A47J 37/015; A47J 36/027; A47J 37/0611

(57) ABSTRACT

A specific cooking vessel for microwave oven includes upper and lower baking trays, upper and lower tray covers. The outer surfaces of the upper and lower baking trays are provided with microwave-absorbing heating layers. Each of the upper and lower tray covers includes a tray cover part and an edge banding part. The tray cover parts of the upper and lower tray covers are respectively provided with snap holes, and the snap holes are provided with detachable upper and lower cover clamps. The rotating ends of the upper and lower cover clamps are hinged to each other to drive the synchronous rotation and opening and closing of the upper and lower baking trays and the upper and lower tray covers. The upper and lower baking trays, upper and lower tray covers, and upper and lower cover clamp can be disassembled, facilitating cleaning after cooking.

### CROSS-REFERENCE

This application is a continuation of International Application No. PCT/CN2023/134635 with a filling date of November 28, 2023, designating the United States, now pending, which further claims to the benefit of priority from Chinese Application No. 202323139035.7 with a filing date of November 20, 2023. The content of the aforementioned applications, including any intervening amendments thereto, are incorporated herein by reference.

### TECHNICAL FIELD

The present disclosure relates to the technical field of cookware for microwave ovens, in particular to a specific cooking vessel for microwave oven.

### BACKGROUND

The use of microwave ovens for cooking and processing has the advantages of convenience, efficient, and good safety, especially suitable for cooking and processing semi-finished ingredients and pre-made dishes.

CN201520707248.1 discloses an improved detachable microwave baking tray, which includes an upper baking tray and a lower baking tray that are separately arranged. The upper baking tray is equipped with an upper baking tray cavity, and the lower baking tray is equipped with a lower baking tray cavity. The lower baking tray has lower handles on both sides, and the lower handles are integrally extended with elastic silicone fasteners. The upper baking tray has upper handles on both sides, and the upper handles have corresponding fastening protrusions that match the elastic fasteners. Through the cooperation of the elastic silicone fasteners and the fastening protrusions, the upper baking tray and the lower baking tray are connected into a whole, and the upper baking tray cavity and the lower baking tray cavity are connected to form a heating chamber suitable for baking food. In this technical solution, the upper and lower baking trays are connected through elastic silicone fasteners, which is cumbersome to operate and not convenient for cooking sandwiches and other items.

### SUMMARY

The objective of the present disclosure is to provide a specific cooking vessel for microwave oven, which solves the problems of cumbersome operation and inconvenience in cooking sandwiches and other items by using elastic silicone fasteners to connect upper and lower baking trays, so as to overcome the shortcomings of existing technology.

The technical solution of the present disclosure: a specific cooking vessel for microwave oven, including an upper baking tray and a lower baking tray, an upper tray cover and a lower tray cover, outer surfaces of the upper baking tray and the lower baking tray are provided with microwave-absorbing heating layers, and each of the upper tray cover and the lower tray cover comprises a cover part and an edge banding part, wherein the cover parts of the upper tray cover and the lower tray cover are respectively provided with snap holes, and the upper cover clamp and the lower cover clamp are detachably provided inside the snap holes; the upper cover clamp and the lower cover clamp is respectively provided with a rotating end and an opening and closing end, and the rotating ends of the upper cover clamp and the lower cover clamp are hinged to each other to drive the upper baking tray and the lower baking tray as well as the upper tray cover and the lower tray cover to rotate synchronously for opening or closing.

The surfaces of the cover parts of the upper tray cover and the lower tray cover are provided with a plurality of snap holes, the inner walls of the upper cover clamp and the lower cover clamp is provided with a plurality of snap fasteners corresponding to the snap holes, and the snap holes and the snap fasteners form a locking pair connecting the upper tray cover and the lower tray cover as well as the upper cover clamp and the lower cover clamp.

The opening and closing end of the upper cover clamp is provided with a buckle, the opening and closing end of the lower cover clamp is provided with a hook corresponding to the buckle, the buckle and the hook are capable of being connected to achieve a closure and locking of the upper cover clamp and the lower cover clamp, and the buckle and the hook are capable of being disconnected to achieve an opening of the upper cover clamp and the lower cover clamp.

The sides of the upper baking tray and the lower baking tray facing the opening and closing ends of the upper tray cover and the lower tray cover are front sides of the upper baking tray and the lower baking tray, the front side and edges of sides adjacent to the front sides of the upper baking tray and the lower baking tray are provided with extended edges extending outwardly, the extended edges of the front side of the upper baking tray and the extended edge of the front side of the lower baking tray are provided with wave shaped surfaces that match with each other.

The extended edge on the front side of the upper baking tray and the extended edge on the front side of the lower baking tray are further provided with multiple sets of interlocking protrusions and grooves.

The edges of the upper baking tray and the lower baking tray have convex edges extending towards each other, and outer circumferences of the convex edges are provided with embedding edges protruding outwardly.

Rotating ends of the upper cover clamp and the lower cover clamp are respectively equipped with a hinge assembly. The hinge assembly includes an upper shaft sleeve, an upper limit block, and an upper hinge shaft arranged in sequence, and the hinge assembly of the lower cover clamp comprises a lower hinge shaft, a lower limit block, and a lower shaft sleeve arranged in sequence.

The hinge assembly is further provided with a support, and when the upper cover clamp rotates and opens to an obtuse angle, the upper cover clamp presses against the support to maintain an open position of the upper cover clamp.

The upper tray cover and the lower tray cover are processed and formed from silicone.

The present disclosure has the following advantageous effects: by setting the upper and lower cover clamp on the upper and lower tray covers, the opening and closing of the upper and lower baking trays are capable of being driven, which facilitates the cooking and processing of sandwiches and other items quickly and conveniently. The upper and lower baking trays, the upper and lower tray covers, and the upper and lower cover clamp are disassembled, which also facilitates cleaning after cooking, and solves the problems of cumbersome operation and inconvenient cleaning.

### BRIEF DESCRIPTION OF THE DRAWINGS

FIG. 1 is an overall schematic diagram of the specific cooking vessel for microwave oven disclosed in the present disclosure.

FIG. 2 is an exploded view of the cooking vessel disclosed in the present disclosure.

FIG. 3 is a schematic diagram of the structure of the upper cover clamp and upper tray covers of the cooking vessel disclosed in the present disclosure.

FIG. 4 is a front sectional view of the cooking vessel disclosed in the present disclosure.

FIG. 5 is an enlarged sectional view of portion A in FIG. 4.

FIG. 6 is a lateral sectional view of the cooking vessel disclosed in the present disclosure.

FIG. 7 is a schematic diagram of the structure of the upper tray assembly and the lower baking tray assembly of the cooking vessel disclosed in the present disclosure.

FIG. 8 is an unfolded schematic diagram of the hinge assembly of embodiment 1 of the cooking vessel disclosed in the present disclosure.

FIG. 9 is a schematic diagram of the hinge assembly in the open position of the disclosed embodiment 1.

FIG. 10 is a front sectional view of the hinge assembly of the disclosed embodiment 1.

FIG. 11 is an unfolded schematic diagram of the hinge assembly of embodiment 2 of the cooking vessel disclosed in the present disclosure

FIG. 12 is a schematic diagram of the hinge assembly in the open position of the disclosed embodiment 2.

FIG. 13 is a front sectional view of the hinge assembly of the disclosed embodiment 2.

### DETAILED DESCRIPTION OF THE EMBODIMENTS

The technical solution of this application will be clearly and completely described in conjunction with the accompanying drawings. It should be understood that many changes, modifications, substitutions and variations can be made to these embodiments without departing from the principles and spirit of the present disclosure. The scope of the present disclosure is defined by the appended claims and their equivalents.

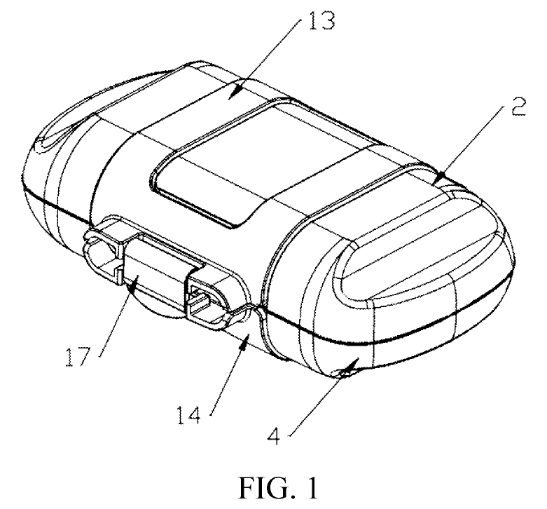

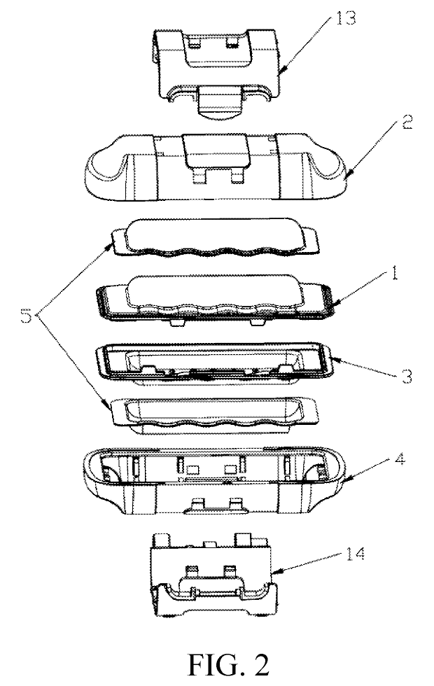

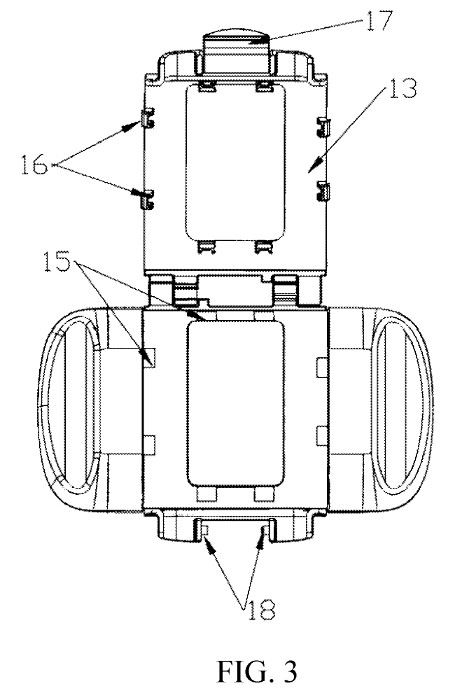

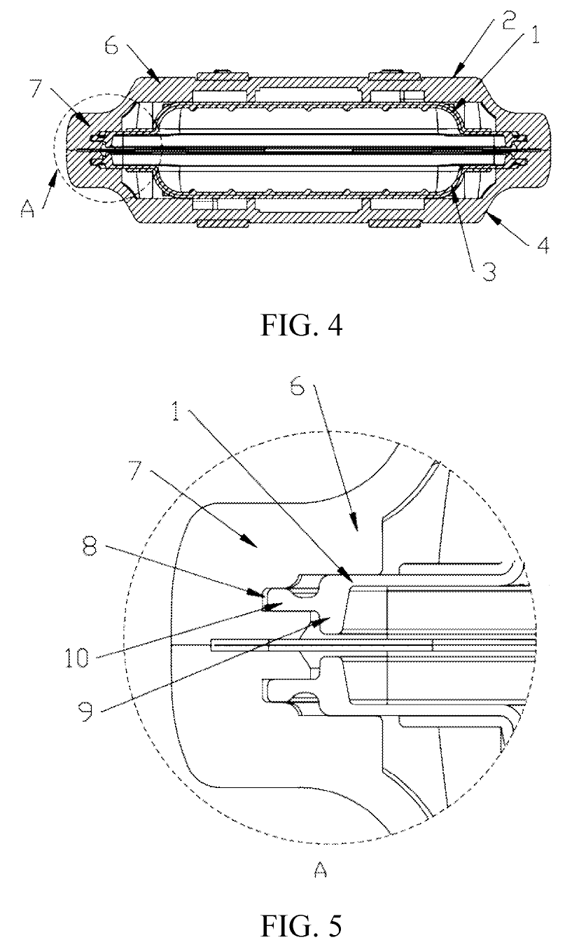

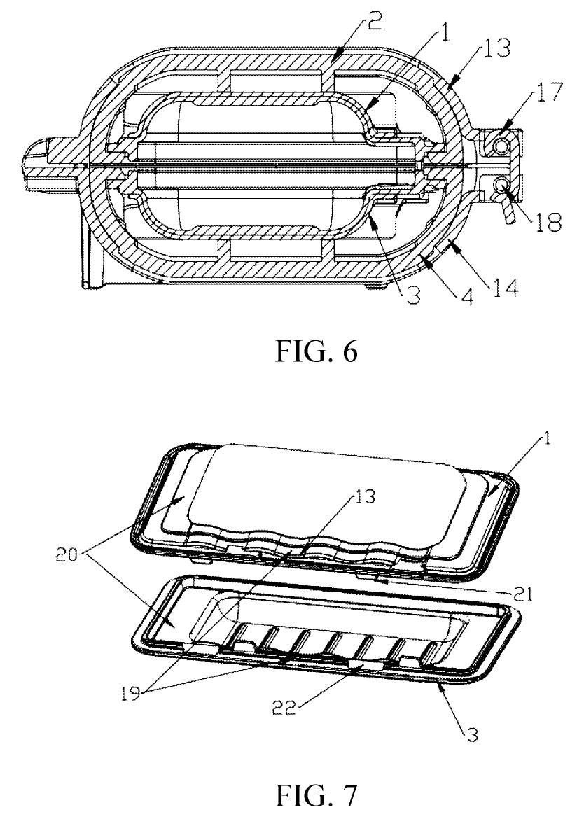

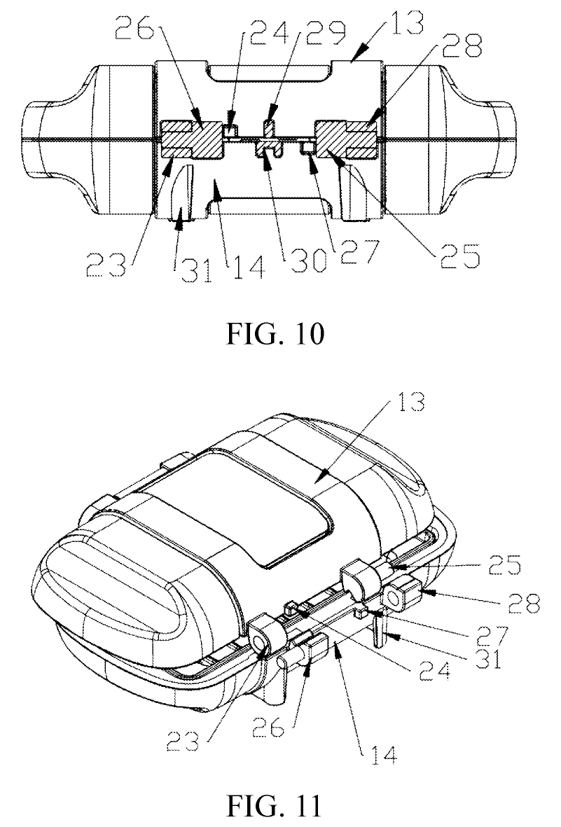

Referring to FIG. 1 to FIG. 10, the specific cooking vessel for microwave oven includes an upper baking tray 1 and an upper tray cover 2, a lower baking tray 3 and a lower tray cover 4. The outer surfaces of the upper baking tray and the lower baking tray are provided with a microwave-absorbing heating layer 5 respectively. The upper tray cover 2 and the lower tray cover 4 are formed from silicone or soft plastic, each of which includes a cover part 6 and an edge banding part 7. An insertion slot 8 is formed at the joint between the cover part 6 and the edge banding part 7. The edges of the upper baking tray and the lower baking tray are provided with convex edges 9 extending towards each other, the outer side of the convex edge 9 is circumferentially provided with an outwardly protruding embedding edge 10, and the embedding edge 10 is inserted into the insertion slot 8, so that the upper baking tray 1, the upper tray cover 2, and the lower baking tray 3 and the lower tray cover 4 can be installed and fixed.

The cover parts 6 of the upper tray cover and lower tray cover are respectively provided with a plurality of snap holes 15. The inner walls of the upper cover clamp 13 and the lower cover clamp 14 are provided with a plurality of snap fasteners 16 corresponding to the snap holes 15. When the snap fasteners 16 are aligned with the snap holes 15 and inserted for fixation, the upper cover clamp 13 and the lower cover clamp 14 can be respectively installed on the upper tray cover 2 and the lower tray cover 4, thereby achieving the installation and fixation of the upper cover clamp 13 and the upper tray cover 2, as well as the lower cover clamp 14 and the lower tray cover 4. The upper cover clamp and the lower cover clamp have a rotating end and an opening and closing end respectively. The rotating ends of the upper cover clamp 13 and the lower cover clamp 14 are hinged to each other, which drives the upper baking tray and lower baking tray as well as the upper tray cover and lower tray cover to rotate and open synchronously. After the upper baking tray and lower baking tray as well as the upper tray cover and lower tray cover are closed, a closed cooking chamber is formed between the upper baking tray 1 and the lower baking tray 2. When the microwave acts on the microwave-absorbing heating layer 5, the microwave-absorbing heating layer 5 absorbs the microwave and converts it into heat energy, which is then conducted to the upper baking tray 1 and the lower baking tray 3, so that the upper baking tray 1 and the lower baking tray 3 cook the food in the cooking chamber.

After the upper baking tray and lower baking tray as well as the upper tray cover and the lower tray cover are closed, the edge banding parts 7 of the upper tray cover and the lower tray cover are in close contact with each other, fully enclosing the upper baking tray and the lower baking tray. In addition, it is also possible to maintain a certain gap between the upper baking tray and the lower baking tray, so that there will be no sparking caused by the contact between the upper baking tray 1 and the lower baking tray 3.

The opening and closing end of the upper cover clamp 13 is provided with a buckle 17, and the opening and closing end of the lower cover clamp 14 is provided with hooks 18 corresponding to the buckle 17. The connection between the buckle 17 and the hooks 18 can achieve the closure and locking of the upper cover clamp and the lower cover clamp, and the cooking chamber between the upper baking tray 1 and the lower baking tray 2 is in a stable closed state, improving the quality of food cooking; after cooking, the buckle 17 is disengaged from the hooks 18, and the upper baking tray 1 is opened by rotating the upper cover clamp 13, so that the cooked food can be taken out.

The sides of the upper baking tray and the lower baking tray facing the opening and closing ends of the upper cover clamp and the lower cover clamp are the front sides of the upper baking tray and the lower baking tray. The edges of the front side and the adjacent sides of the upper baking tray and the lower baking tray are respectively provided with an extended edge 19 and an extended edge 20 extending outwards. When the upper baking tray 1 and the lower baking tray 3 are closed, the edge of the cooking chamber is formed between the extended edges 19 on the front sides of the upper baking tray and the lower baking tray and the extended edges 20 on the adjacent sides. The thickness of the edge of the cooking chamber is smaller than that of the middle part of the cooking chamber. When cooking sandwiches, various ingredients are usually added in the middle of the overlapping sliced breads. Therefore, the thickness of the edge of the cooking chamber is small, which can squeeze and close the edges of the overlapping sliced breads, forming an edge sealing. While the middle part of the cooking chamber is thicker, which can better accommodate various ingredients, thus improving the cooking effect of the sandwich. In this embodiment, the extended edges 19 on the front sides of the upper baking tray 1 and the lower baking tray 3 are provided with a wave shaped surface that cooperates with each other, which can cook sandwiches with wavy edges and enhances the presentation of food. The extension edges 19 on the front sides of the upper baking tray 1 and the lower baking tray 3 are also provided with multiple sets of interlocking protrusion 21 and grooves 22. When making a sandwich with a piece of bread, the two ends of the bread can be respectively pressed against the protrusion 21 of the upper baking tray 1 and the lower baking tray 3, so that when the upper baking tray 3 and the lower baking tray 3 are closed after adding ingredients, the bread slices will not move due to the restriction of the protrusion 21, thus ensuring the cooking effect. The mutually meshed protrusion 21 and grooves 22 arranged on the upper baking tray 1 and the lower baking tray 3 can not only realize the normal closing of the upper baking tray 1 and the lower baking tray 3, but also avoid of sparking when the upper baking tray 1 comes into contact with the lower baking tray 3.

The rotating ends of the upper cover clamp and the lower cover clamp are respectively provided with hinge assemblies. The hinge assembly of the upper cover clamp 13 includes an upper shaft sleeve 23, an upper limit block 24, and an upper hinge shaft 25 arranged in sequence, while the hinge assembly of the lower cover clamp 14 includes a lower hinge shaft 26, a lower limit block 27, and a lower shaft sleeve 28 arranged in sequence. The lower hinge shaft 26 is inserted into the upper shaft sleeve 23, and the upper shaft sleeve 23 and the upper limit block 24 are located on both sides of the lower hinge shaft 26. The upper hinge shaft 25 is inserted into the lower shaft sleeve 28, and the lower shaft sleeve 28 and the lower limit block 27 are located on both sides of the upper hinge shaft 25, which can achieve stable rotation of the lower hinge shaft 26 in the upper shaft sleeve 23 and the upper hinge shaft 25 in the lower shaft sleeve 28. The upper cover clamp 13 and the lower cover clamp 14 are hinged to each other, at the same time, the tops of the upper hinge shaft 25 and the lower hinge shaft 26 are respectively provided with gaps corresponding to the lower limit block 27 and the upper limit block 24. When the upper cover clamp 13 rotates to the corresponding angle, the lower limit block 27 and the upper limit block 24 align with the corresponding gaps, and the upper cover clamp 13 or the lower cover clamp 14 is capable of being moved in the axial direction, which allow the upper hinge shaft 25 and the lower hinge shaft 26 respectively to avoid the lower limit block 27 and the upper limit block 24, and then release the lower shaft sleeve 28 and the upper shaft sleeve 23, thereby releasing the hinge of the upper cover clamp 13 and the lower cover clamp 14, facilitating cleaning and maintenance of various components after use. After cleaning, follow the previous steps and insert the upper hinge shaft 25 and the lower hinge shaft 26 back into the lower shaft sleeve 28 and the upper shaft sleeve 23 at the corresponding angles to restore the hinge connection between the upper cover clamp 13 and the lower cover clamp 14. The corresponding angle above refers to the angle between the upper baking tray 1 and the lower baking tray 3. The angle when the upper baking tray 1 and the lower baking tray 3 are closed is defined as 0°, and the corresponding angle can be any angle other than 0°.

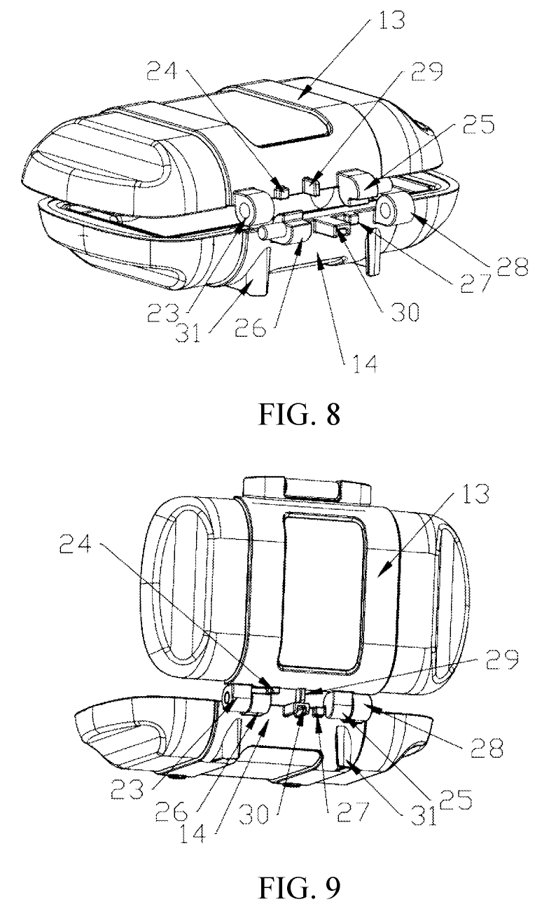

As shown in FIG. 8 to FIG. 10, in embodiment 1, the hinge assembly further includes a support foot 29 arranged in the middle of the rotating end of the upper cover clamp 13 and a support base 30 corresponding to the support foot 29 arranged at the rotating end of the lower cover clamp 14. When the upper cover clamp 13 rotates and opens to an obtuse angle, the support foot 29 presses against the support base 30 to maintain the open position of the upper cover clamp 13, avoiding inconvenience caused by the need for the user to manually hold the upper tray cover 2. In this embodiment, the positions of the support foot 29 and the support base 30 can also be interchanged, that is, the support foot 29 is arranged on the lower cover clamp 14, and the support base 30 is arranged on the upper cover clamp 13.

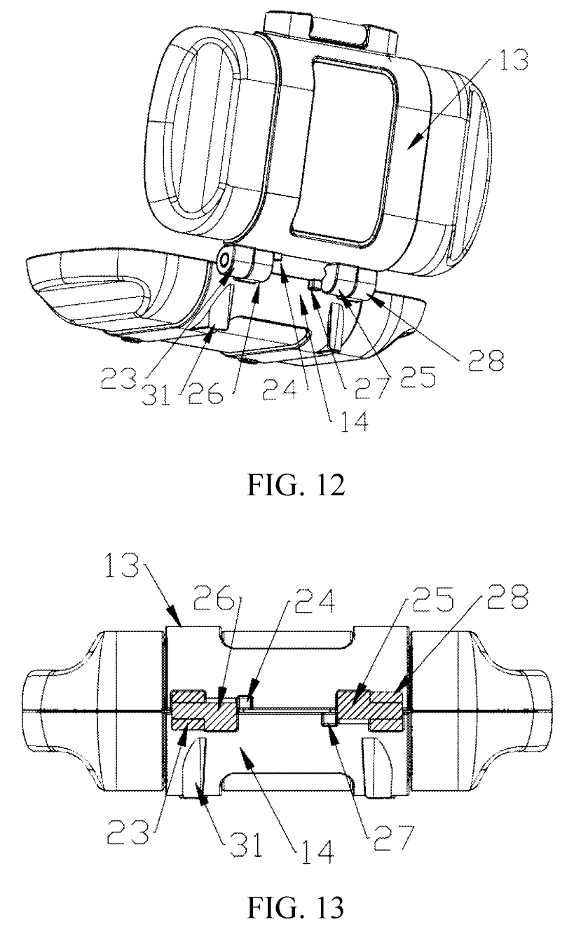

As shown in FIG. 11 to FIG. 13, in embodiment 2, a limit structure is arranged on the upper surfaces of the lower hinge shaft 26 and the lower shaft sleeve 28, which intersects with the rotation trajectory of the upper cover clamp 13. This ensures that when the upper cover clamp 13 is opened to an obtuse angle, the upper cover clamp 13 is pressed against the limit structure on the upper surfaces of the lower hinge shaft 26 and the lower shaft sleeve 28, thereby maintaining the open position of the upper cover clamp 13. In this embodiment, the limit structure can also be arranged on the upper hinge shaft 25 and the upper shaft sleeve 23. When the upper cover clamp 13 is opened to an obtuse angle, the limit structures on the upper hinge shaft 25 and the upper shaft sleeve 23 are pressed against the lower cover clamp 14, which can also maintain the open position of the upper cover clamp 13. The limit structure can be a limit plane or limit protrusion arranged on the upper surfaces of the lower hinge shaft 26 and the lower shaft sleeve 28 or the upper hinge shaft 25 and the upper shaft sleeve 23.

The bottom of the lower cover clamp 14 is provided with a plurality of support legs 31, which can maintain the stability of the cookware during placement. The support legs 31 can also be arranged at the bottom of the lower tray cover 4.

The upper cover clamp and the lower cover clamp are made of plastic and can be used in microwave ovens, having good strength and relatively light weight.

The other structures of embodiment 2 are the same as those of embodiment 1.

What is claimed is:

1. A specific cooking vessel for a microwave oven, comprising an upper baking tray and a lower baking tray, an upper tray cover and a lower tray cover, outer surfaces of the upper baking tray and the lower baking tray are provided with microwave-absorbing heating layers, and each of the upper tray cover and the lower tray cover comprises a cover part and an edge banding part;
wherein the cover parts of the upper tray cover and the lower tray cover are respectively provided with snap holes, and the upper cover clamp and the lower cover clamp are detachably provided inside the snap holes; the upper cover clamp and the lower cover clamp is respectively provided with a rotating end and an opening and closing end, and the rotating ends of the upper cover clamp and the lower cover clamp are hinged to each other to drive the upper baking tray and the lower baking tray as well as the upper tray cover and the lower tray cover to rotate synchronously for opening or closing;
rotating ends of the upper cover clamp and the lower cover clamp are respectively equipped with a hinge assembly;
the hinge assembly of the upper cover clamp comprises an upper shaft sleeve, an upper limit block, and an upper hinge shaft arranged in sequence; the hinge assembly of the lower cover clamp comprises a lower hinge shaft, a lower limit block, and a lower shaft sleeve arranged in sequence;
the lower hinge shaft is inserted into the upper shaft sleeve, and the upper shaft sleeve and the upper limit block are located on both sides of the lower hinge shaft; the upper hinge shaft is inserted into the lower shaft sleeve, and the lower shaft sleeve and the lower limit block are located on both sides of the upper hinge shaft, so as to ensure stable rotation of the lower hinge shaft in the upper shaft sleeve and the upper hinge shaft in the lower shaft sleeve, and the upper cover clamp and the lower cover clamp are hinged to each other.

2. The specific cooking vessel for a microwave oven according to claim 1, wherein tops of the upper hinge shaft and the lower hinge shaft are respectively provided with gaps corresponding to the lower limit block and the upper limit block; when the upper cover clamp rotates to a corresponding angle, the lower limit block and the upper limit block align with the corresponding gaps, and the upper cover clamp or the lower cover clamp are capable of being moved in an axial direction to allow the upper hinge shaft and the lower hinge shaft respectively to avoid the lower limit block and the upper limit block, and then release the lower shaft sleeve and the upper shaft sleeve, thereby releasing a hinge of the upper cover clamp and the lower cover clamp.

3. The specific cooking vessel for a microwave oven according to claim 1, wherein surfaces of the cover parts of the upper tray cover and the lower tray cover are provided with a plurality of snap holes, inner walls of the upper cover clamp and the lower cover clamp is provided with a plurality of snap fasteners corresponding to the snap holes, and the snap holes and the snap fasteners form a locking pair connecting the upper tray cover and the lower tray cover and the upper cover clamp and the lower cover clamp.

4. The specific cooking vessel for a microwave oven according to claim 1, wherein the opening and closing end of the upper cover clamp is provided with a buckle, the opening and closing end of the lower cover clamp is provided with a hook corresponding to the buckle, the buckle and the hook are capable of being connected to achieve a closure and locking of the upper cover clamp and the lower cover clamp, and the buckle and the hook are capable of being disconnected to achieve an opening of the upper cover clamp and the lower cover clamp.

5. The specific cooking vessel for a microwave oven according to claim 1, wherein sides of the upper baking tray and the lower baking tray facing the opening and closing ends of the upper tray cover and the lower tray cover are front sides of the upper baking tray and the lower baking tray, the front side and edges of sides adjacent to the front sides of the upper baking tray and the lower baking tray are provided with extended edges extending outwardly, the extended edges of the front side of the upper baking tray and the extended edge of the front side of the lower baking tray are provided with wave shaped surfaces that match with each other.

6. The specific cooking vessel for a microwave oven according to claim 5, wherein the extended edge on the front side of the upper baking tray and the extended edge on the front side of the lower baking tray are further provided with multiple sets of interlocking protrusions and grooves.

7. The specific cooking vessel for a microwave oven according to claim 5, wherein the edges of the upper baking tray and the lower baking tray have convex edges extending towards each other, and outer circumferences of the convex edges are provided with embedding edges protruding outwardly.

8. The specific cooking vessel for a microwave oven according to claim 1, wherein the hinge assembly is further provided with a support, and when the upper cover clamp rotates and opens to an obtuse angle, the upper cover clamp presses against the support to maintain an open position of the upper cover clamp.

9. The specific cooking vessel for a microwave oven according to claim 1, wherein the upper tray cover and the lower tray cover are processed and formed from silicone.
